(19) United States
(12) Patent Application Publication
(10) Pub. No.: US 2007/0205031 A1
(43) Pub. Date: Sep. 6, 2007

(54) Control device for hybrid electric vehicle

(76) Inventor: Makoto Ogata, Kanagawa (JP)

Correspondence Address: JACOBSON HOLMAN PLLC, 400 SEVENTH STREET N.W., SUITE 600, WASHINGTON, DC, 20004, US

(21) Appl. No.: 11/714,212

(22) Filed: Mar. 6, 2007

(30) Foreign Application Priority Data
Mar. 6, 2006 (JP) 2006-059386

(51) Int. Cl. B60K 1/00

(52) U.S. Cl. 180/65.2

(57) ABSTRACT

A hybrid electric vehicle is arranged such that a driving force of an electric motor can be transmitted to driving wheels, and a rotary shaft of the motor can be coupled with an output shaft of an engine. When a starting switch is switched from the first to the second position, a start control unit starts power supply from a battery to a power control unit. When the starting switch is switched from the second to the third position, the start control unit starts the engine by the electric motor if a control of the power supply to the electric motor can be executed by the power control unit, and, on the other hand, starts the engine by a starter motor if the control of the power supply to the electric motor is not possible to be executed by the power control unit.

### BACKGROUND OF THE INVENTION

1. Field of the Invention

The present invention relates to a control device for a hybrid electric vehicle, and more particularly, to a control device for a hybrid electric vehicle arranged such that a driving force of an electric motor can be transmitted to driving wheels of the vehicle and also the rotary shaft of the electric motor can be coupled with the output shaft of an engine.

2. Description of the Related Art

A so-called parallel hybrid electric vehicle configured such that the driving force of the engine as well as that of the electric motor can be transmitted to the driving wheels of the vehicle, has been developed and put to practical use.

In this type of hybrid electric vehicle, the output shaft of the engine can be coupled with the rotary shaft of the electric motor, and thus, the engine can be started by making use of the driving force of the electric motor which is operated as a motor.

A hybrid electric vehicle using the driving force of the electric motor to start the engine is disclosed, for example, in Unexamined Japanese Patent Publication No. 2000-64873 (hereinafter referred to as Patent Document 1).

In the hybrid electric vehicle proposed in Patent Document 1, when large driving force is demanded because of, for example, rapid acceleration of the vehicle while the vehicle is driven solely by the electric motor with the engine stopped, the engine is automatically started by the motor so that the engine may also produce driving force. At this time, if the battery voltage is lower than a set value or if a cranking signal of the engine fails to be detected, then the engine cannot be started by the electric motor. In such cases, the engine is started by using a starter motor, instead of the electric motor.

A hybrid electric vehicle using the driving force of the electric motor to start the engine is also proposed in Unexamined Japanese Patent Publication No. 2004-339943 (hereinafter referred to as Patent Document 2), for example.

Also in the hybrid electric vehicle disclosed in Patent Document 2, when large driving force is demanded due to, for example, rapid acceleration of the vehicle while the vehicle is driven solely by the electric motor with the engine stopped, the engine is automatically started by the electric motor to produce driving force, as in the hybrid electric vehicle of Patent Document 1. At this time, the driving torque may possibly run short because the engine is started by the electric motor and thus the driving force of the electric motor is used for the purpose other than the driving of the vehicle. Accordingly, if the torque required to drive the vehicle is greater than a reference value, the engine is started by the starter motor, in place of the electric motor.

Thus, various methods have been proposed to solve the problems that arise depending on the operating state of the vehicle when the engine is automatically started while the vehicle is driven solely by the driving force of the electric motor. However, these methods do not take into account the case where the starting switch is operated by driver to start the engine.

Specifically, a hybrid electric vehicle is configured in the following manner: When the starting switch is turned to the ON position by the driver, the battery is connected to an inverter for controlling the power supply to the electric motor. When the starting switch is thereafter turned to the START position by the driver, the electric power of the battery is supplied via the inverter to the electric motor to start the engine.

The voltage of the battery is, however, generally high, and since a large inrush current flows when the battery is connected to the inverter, a circuit (inrush current suppression circuit) is provided to suppress the inrush current. While the inrush current suppression circuit is in operation, the voltage applied to the inverter lowers due to the voltage drop induced by the inrush current suppression circuit. Consequently, the electric motor cannot be operated to start the engine until the operation of the inrush current suppression circuit is completed.

Thus, if the driver turns the starting switch to the ON position and then to the START position immediately thereafter, the electric motor does not start its operation until the operation of the inrush current suppression circuit is completed. It is after a while that the electric motor is operated to start the engine. Accordingly, the driver may possibly mistake such a delay in engine start for a failure or operation feeling in starting the engine may be deteriorated.

### SUMMARY OF THE INVENTION

An aspect of the present invention is directed to a control device for a hybrid electric vehicle which includes an electric motor and an engine and which is arranged such that a driving force of the electric motor can be transmitted to driving wheels and a rotary shaft of the electric motor can be coupled with an output shaft of the engine, the control device comprising a battery which stores electric power to be supplied to the electric motor; power control means adapted to be supplied with electric power from the battery, for executing a control of power supply to the electric motor; control judging means for judging whether or not the control of the power supply to the electric motor can be executed by the power control means; a starter motor provided separately from the electric motor and capable of starting the engine by transmitting driving force generated thereby to the output shaft of the engine; a starting switch adapted to be switched to one of at least three positions including first, second and third positions; and start control means for starting power supply from the battery to the power control means when the starting switch is switched from the first position to the second position, wherein, when the starting switch is switched from the second position to the third position, the start control means causes the power control means to execute the control of the power supply to the electric motor to start the engine by the electric motor if it is judged by the control judging means that the control of the power supply to the electric motor can be executed by the power control means, and, on the other hand, the start control means starts the engine by the starter motor if it is judged by the control judging means that the control of the power supply to the electric motor is not possible to be executed by the power control means.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 shows a substantial part of a hybrid electric vehicle having a control device according to one embodiment of the present invention;

FIG. 2 shows an inverter and its associated elements in the hybrid electric vehicle of FIG. 1; and

FIG. 3 is a flowchart illustrating start control executed in the hybrid electric vehicle of FIG. 1.

### DETAILED DESCRIPTION OF THE INVENTION

An embodiment of the present invention will be hereinafter described with reference to the accompanying drawings.

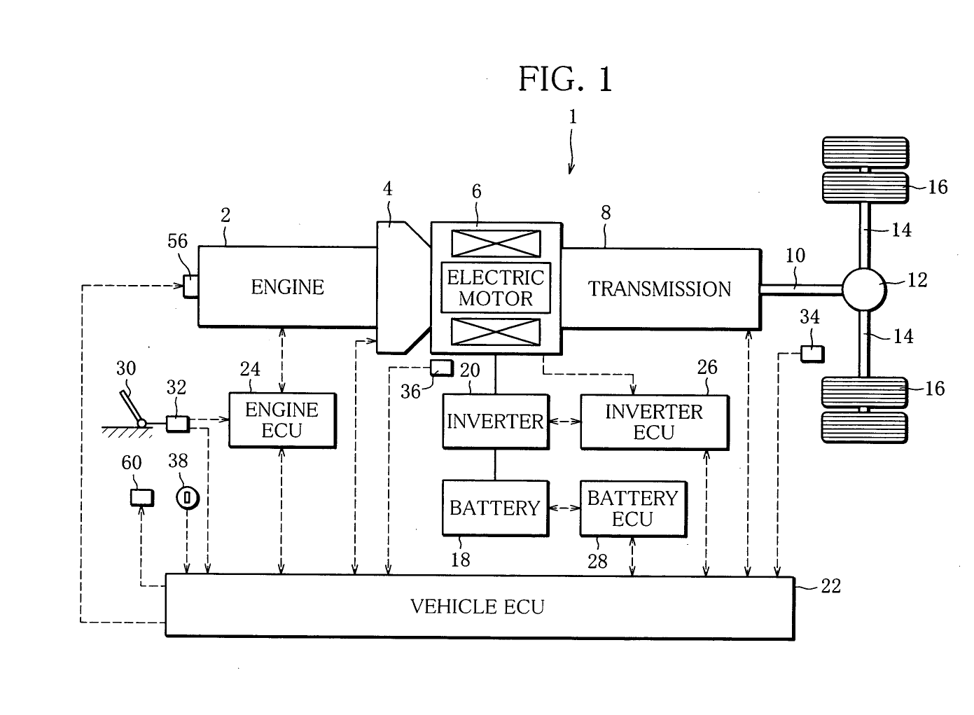

FIG. 1 shows a substantial part of a hybrid electric vehicle 1 to which the present invention is applied. An input shaft of a clutch 4 is coupled to an output shaft of an engine 2, which is a diesel engine. An output shaft of the clutch 4 is coupled to an input shaft of an automatic transmission (hereinafter, referred to as transmission) 8 through a rotary shaft of a permanent-magnetic synchronous motor (hereinafter, referred to as electric motor) 6. An output shaft of the transmission 8 is connected to right and left driving wheels 16 through a propeller shaft 10, a differential 12, and driving shafts 14.

Thus, when the clutch 4 is engaged, the output shaft of the engine 2 and the rotary shaft of the electric motor 6 are coupled together and can be mechanically connected with the driving wheels 16 through the transmission 8. On the other hand, when the clutch 4 is disengaged, the output shaft of the engine 2 is disconnected from the rotary shaft of the electric motor 6, and thus only the rotary shaft of the electric motor 6 can be mechanically connected with the driving wheels 16 through the transmission 8.

The electric motor 6 is operated as a motor when DC power stored in a battery 18 is supplied to the electric motor 6 after being converted to AC power by an inverter (power control means) 20. A driving torque of the electric motor 6 is transmitted to the driving wheels 16 after being shifted to a suitable speed by the transmission 8. When the vehicle is decelerating, the electric motor 6 is operated as a generator. Kinetic energy created by the rotation of the driving wheels 16 is transmitted to the electric motor 6 through the transmission 8 to be converted to AC power, thereby producing a regenerative braking torque. The AC power is then converted to DC power by the inverter 20 and charged to the battery 18. In this manner, the kinetic energy created by the rotation of the driving wheels 16 is recovered as electric energy.

A driving torque of the engine 2 is transmitted to the transmission 8 through the rotary shaft of the electric motor 6 while the clutch 4 is engaged. After being shifted to a suitable speed, the driving torque of the engine 2 is transmitted to the driving wheels 16. Thus, if the electric motor 6 is operated as a motor while the driving torque of the engine 2 is transmitted to the driving wheels 16, both the driving torque of the engine 2 and that of the electric motor 6 are transmitted to the driving wheels 16. In other words, a part of the driving torque to be transmitted to the driving wheels 16 to drive the vehicle is supplied by the engine 2, and at the same time, the rest of the driving torque is supplied by the electric motor 6.

If a storage rate (hereinafter, referred to as SOC) of the battery 18 is so low that the battery 18 needs to be charged, the electric motor 6 is operated as a generator. Moreover, the electric motor 6 is driven by using a part of the driving force of the engine 2, to thereby carry out power generation. As described above, the generated AC power is converted into DC power by the inverter 20, and the battery 18 is charged with this DC power.

A vehicle ECU (start control means) 22 implements engagement/disengagement control of the clutch 4 and the gear shift control of the transmission 8 in accordance with the operating states of the vehicle and engine 2 as well as information supplied from an engine ECU 24, an inverter ECU (control judging means) 26, and a battery ECU 28. The vehicle ECU 22 performs integrated control for properly controlling the engine 2 and the electric motor 6 according to state of the above-mentioned controls, and the various kinds of operating conditions of the vehicle, such as starting, acceleration, and deceleration.

The engine ECU 24 carries out start/stop control of the engine 2 in accordance with information supplied from the vehicle ECU 22. Also, the engine ECU 24 carries out various kinds of controls required in the operation of the engine 2 per se, including idling control of the engine 2, regeneration control of an exhaust gas purification device (not shown), and the like. Further, the engine ECU 24 controls the fuel injection quantity and injection timing of the engine 2 so that the engine 2 generates the torque required in the engine 2, which has been set by the vehicle ECU 22.

The inverter ECU 26 monitors the state of the inverter 20 and sends information about the monitored state to the vehicle ECU 22. Also, the inverter ECU 26 controls the inverter 20 in accordance with the torque to be generated by the electric motor 6, which has been set by the vehicle ECU 22, and thereby controls the operation of the electric motor 6 so that the electric motor 6 is operated as a motor or a generator.

The battery ECU 28 detects the temperature and voltage of the battery 18, the electric current flowing between the inverter 20 and the battery 18, etc. The battery ECU 28 obtains the SOC of the battery 18 from these detection results, and sends the obtained SOC to the vehicle ECU 22 together with the detection results.

While exchanging information with the engine ECU 24, the inverter ECU 26 and the battery ECU 28, the vehicle ECU 22 instructs the engine ECU 24 and the inverter ECU 26 to properly control the engine 2 and the electric motor 6, respectively, and also suitably controls the clutch 4 and the transmission 8.

When performing such control actions, the vehicle ECU 22 calculates required torque necessary to run the vehicle, based on detection results provided by an accelerator position sensor 32 for detecting the amount of depression of an accelerator pedal 30 for detecting the depression amount of an accelerator pedal 30, a vehicle speed sensor 34 for detecting the traveling speed of the vehicle, and a revolution speed sensor 36 for detecting the revolution speed of the electric motor 6. Then, based on the information supplied from the individual ECUs, the vehicle ECU 22 allots the required torque to the engine 2 and the electric motor 6 in accordance with the current operating states of the vehicle, engine 2 and electric motor 6, and notifies the engine ECU 24 and the inverter ECU 26 of the respective allotted torques. At this time, the vehicle ECU 22 controls the transmission 8 and the clutch 4 as needed.

Where the required torque is allotted to the electric motor 6 only and no torque is allotted to the engine 2, the vehicle ECU 22 disengages the clutch 4 and instructs the inverter ECU 26 to set the output torque of the electric motor 6 to the required torque.

In this case, since no torque is allotted to the engine 2, the engine ECU 24 allows the engine 2 to idle. On the other hand, the inverter ECU 26 controls the inverter 20 in accordance with the torque instructed from the vehicle ECU 22, so that the DC power of the battery 18 is converted into AC power by the inverter 20 and supplied to the electric motor 6. The electric motor 6 is thus supplied with the AC power and is operated as a motor to output the required torque. The output torque of the electric motor 6 is transmitted to the driving wheels 16 through the transmission 8.

Where the required torque is allotted to both the engine 2 and the electric motor 6, the vehicle ECU 22 engages the clutch 4. Then, the vehicle ECU 22 instructs the engine ECU 24 to set the output torque of the engine 2 to its corresponding allotted torque, and also instructs the inverter ECU 26 to set the output torque of the electric motor 6 to its corresponding allotted torque.

The engine ECU 24 controls the engine 2 so that the allotted torque instructed from the vehicle ECU 22 may be outputted from the engine 2. The inverter ECU 26 controls the inverter 20 in accordance with the allotted torque instructed from the vehicle ECU 22. As a result, the required torque, which is the sum of the output torques of the engine 2 and electric motor 6, is transmitted to the driving wheels 16 through the transmission 8.

Where the required torque is allotted to the engine 2 alone and no torque is allotted to the electric motor 6, the vehicle ECU 22 engages the clutch 4. Then, the vehicle ECU 22 instructs the engine ECU 24 to set the output torque of the engine 2 to the required torque, and also instructs the inverter ECU 26 to set the output torque of the electric motor 6 to zero.

The engine ECU 24 controls the engine 2 so that the required torque instructed from the vehicle ECU 22 may be output from the engine 2. On the other hand, the inverter ECU 26 controls the inverter 20 so that the electric motor 6 is operated neither as a motor nor as a generator. As a result, the required torque outputted from the engine 2 is transmitted to the driving wheels 16 through the transmission 8.

The vehicle ECU 22 is connected with a starting switch 38, which is operated by the driver to permit/inhibit the power supply to individual devices, such as the inverter ECU 26, the battery ECU 28, the engine ECU 24, etc. , and also to start/stop the engine 2. The starting switch 38 can be turned, or switched, to one of three positions including an OFF position (first position) where the power supply to the individual devices is stopped and also the engine 2 is stopped, an ON position (second position) where the individual devices are supplied with power, and a START position (third position) where the engine 2 is started. The starting switch 38 is constructed such that when moved from the ON position to the START position with the driver's hand and then released, the starting switch 38 automatically returns to the ON position.

In accordance with the position of the starting switch 38, the vehicle ECU 22 issues an instruction of the power supply to the individual devices and controls the start/stop of the engine 2.

If, while the starting switch 38 is in the OFF position, that is, while the vehicle is at a standstill, the starting switch 38 is turned to the ON position, the vehicle ECU 22 initiates the power supply to the individual devices. Consequently, the engine ECU 24, the inverter ECU 26 and the battery ECU 28 are supplied with electric power.

When supplied with electric power, the inverter ECU 26 starts its operation and, in order to make the electric motor 6 operative in compliance with the power supply start instruction from the vehicle ECU 22, connects the battery 18 to the inverter 20 through connection units (connection means) 40 provided in the inverter 20.

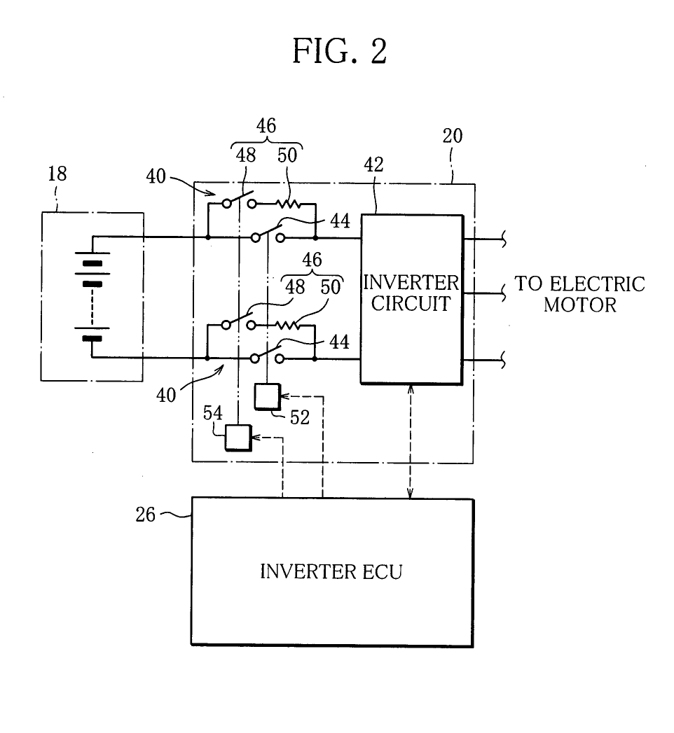

FIG. 2 shows the inverter 20 with the connection units 40.

As shown in FIG. 2, the inverter 20 includes the connection units 40 and an inverter circuit 42 for converting the DC power, supplied thereto from the battery 18 through the connection units 40, into three-phase AC power to be supplied to the electric motor 6. One of the connection units 40 is connected to the positive terminal of the battery 18 and another is connected to the negative terminal of same. Each connection unit 40 is constituted by a main contact 44 for directly connecting the battery 18 to the inverter circuit 42 and an inrush current suppression unit 46 connected in parallel with the main contact 44.

The inrush current suppression unit 46 is provided to restrain a large inrush current from flowing, because of relatively high voltage of the battery 18, when the battery 18 is connected to the inverter circuit 42. Each inrush current suppression unit 46 includes a sub-contact 48 and a current reduction resistor 50 connected in series with the sub-contact 48.

Each main contact 44 closes when an electromagnetic coil 52 is energized, and opens when the coil 52 is de-energized. Each sub-contact 48 closes when an electromagnetic coil 54 is energized, and opens when the coil 54 is de-energized. The coils 52 and 54 have their energized states controlled by the inverter ECU 26 in accordance with the power supply start instruction from the vehicle ECU 22.

Specifically, when the starting switch 38 is turned from the OFF to the ON position, the vehicle ECU 22 issues an instruction to start electric power supply to the individual devices, so that the inverter ECU 26 is supplied with electric power. Then, in response to the power supply start instruction from the vehicle ECU 22, the inverter ECU 26 energizes the coil 54 to close the sub-contacts 48.

Since the sub-contacts 48 are closed, the battery 18 is connected to the inverter circuit 42 through the current reduction resistors 50, and accordingly, inrush current flows while being limited by the resistors 50. In this case, the inverter circuit 42 is applied with a voltage which is lower than the battery voltage by an amount corresponding to the voltage drop induced by the current reduction resistors 50. As the inrush current decreases thereafter, the voltage applied to the inverter circuit 42 approaches the battery voltage.

The inverter ECU 26 monitors the voltage applied to the inverter circuit 42. When the monitored voltage reaches a predetermined voltage close to the battery voltage with decrease of the inrush current, the inverter ECU 26 judges that suppression of the inrush current by the inrush current suppression units 46 is finished, and energizes the coil 52 to close the main contacts 44. The closing of the main contacts 44 completes the connection between the inverter circuit 42 and the battery 18, and thus the inverter circuit 42 is directly applied with the battery voltage. On detecting the application of the battery voltage, the inverter ECU 26 judges that a control of the power supply to the electric motor 6 can be executed by means of the inverter circuit 42, and sends the vehicle ECU 22 information that the control of the power supply to the electric motor 6 is possible to be executed.

On receiving the information, the vehicle ECU 22 switches on an indicator lamp (confirmation means) 60 provided on the instrument panel inside the vehicle compartment.

In this manner, the battery 18 is directly connected to the inverter circuit 42, and the inverter ECU 26 controls the inverter circuit 42 in accordance with instructions from the vehicle ECU 22, to control the power supply to the electric motor 6.

As will be seen from the above, a certain period of time is required after the starting switch 38 is turned from the OFF to the ON position until the control of the power supply to the electric motor 6 becomes possible to be executed by means of the inverter circuit 42 and thereby the electric motor 6 can be operated, and this certain period of time, that is a time delay, corresponds to the time period from the closing of the sub-contacts 48 to the closing of the main contacts 44 after reducing the inrush current.

Where the electric motor 6 is ready for operation, the vehicle ECU 22 engages the clutch 4 to couple the rotary shaft of the electric motor 6 with the output shaft of the engine 2, and after setting the transmission 8 in the neutral position to disconnect the rotary shaft of the electric motor 6 from the driving wheels 16, or after confirming the disconnection, the vehicle ECU 22 can operate the electric motor 6 as a motor to start the engine 2. There is, however, a time delay from the time the starting switch 38 is turned from the OFF to the ON position until the electric motor 6 becomes ready for operation, as mentioned above. Thus, if the starting switch 38 is turned from the OFF to the ON position and then to the START position immediately thereafter, the startup of the engine 2 by the electric motor 6 is delayed.

To eliminate such delay in the startup of the engine 2, the engine 2 is provided with a starter motor 56 separate from the electric motor 6. The starter motor 56 is identical with an engine starter motor used in ordinary vehicles of which the sole driving power source is the engine, and therefore, detailed description thereof is omitted. The starter motor 56 has a pinion gear (not shown) that can be brought into engagement with a ring gear (not shown) fixed on an end portion of the output shaft of the engine 2. The starter motor 56 rotates the output shaft of the engine 2 with the pinion gear in mesh with the ring gear, to start the engine 2.

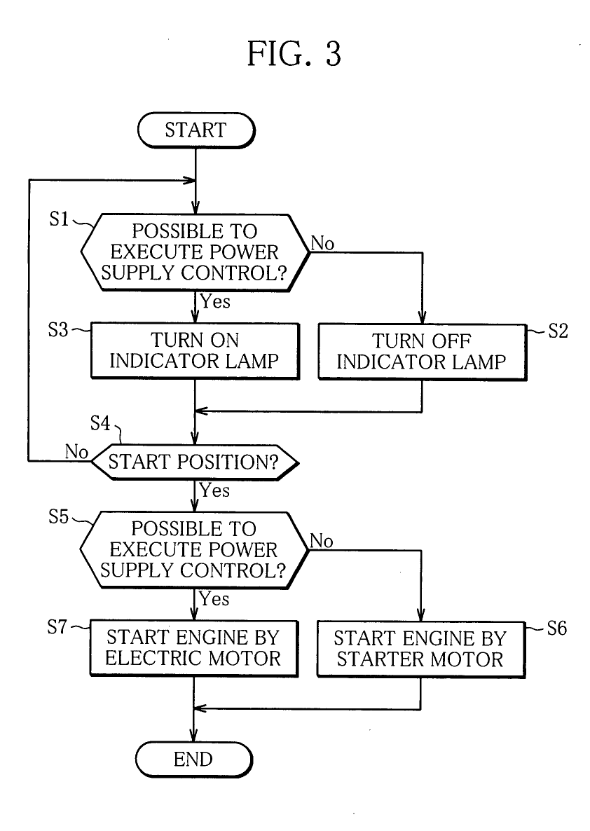

In order for the engine 2 to be selectively started by the starter motor 56 or the electric motor 6 as needed, the vehicle ECU 22 executes start control for the engine 2, shown in the flowchart of FIG. 3. The start control is started when the starting switch 38 is turned from the OFF position to the ON position.

Upon start of the start control, the vehicle ECU 22 determines in Step S1 whether or not the control of the power supply to the electric motor 6 can be executed by means of the inverter circuit 42, based on the information supplied from the inverter ECU 26.

If the starting switch 38 has just been turned from the OFF to the ON position and thus suppression of the inrush current by the inrush current suppression units 46 is not finished yet, the inverter ECU 26 judges that the control of the power supply to the electric motor 6 is not possible to be executed by means of the inverter circuit 42. In this case, the vehicle ECU 22 advances the process to Step S2, in accordance with the judgment by the inverter ECU 26.

In Step S2, the vehicle ECU 22 turns off the indicator lamp 60 (keeps the lamp 60 switched off) because the control of the power supply to the electric motor 6 is not possible to be executed, whereupon the vehicle ECU 22 advance the process to Step S4.

On the other hand, if a certain period of time has elapsed after the starting switch 38 is turned from the OFF to the ON position, and suppression of the inrush current by the inrush current suppression units 46 is finished, so that the battery 18 and the inverter circuit 42 are connected to each other with the main contacts 44 closed, the inverter ECU 26 judges that the control of the power supply to the electric motor 6 can be executed by means of the inverter circuit 42. In accordance with the judgment by the inverter ECU 26, the vehicle ECU 22 advances the process to Step S3.

In Step S3, the vehicle ECU 22 turns on the indicator lamp 60 because the control of the power supply to the electric motor 6 can be executed, whereupon the vehicle ECU 22 advances the process to Step S4.

Thus, in Steps S1 to S3, the vehicle ECU 22 turns the indicator lamp 60 on or off depending on whether the control of the power supply to the electric motor 6 is possible to be executed or not. By taking a look at the indicator lamp 60, therefore, the driver can confirm whether the control of the power supply to the electric motor 6 is possible to be executed or not. In this embodiment, the indicator lamp 60 located on the instrument panel is used as the confirmation means, but the confirmation means may alternatively be configured to provide information by using voice or some other means.

In Step S4, the vehicle ECU 22 determines whether or not the starting switch 38 has been turned to the START position. If the starting switch 38 is not in the START position, the process returns to Step S1, in which the vehicle ECU 22 confirms the judgment of the inverter ECU 26 as to whether or not the control of the power supply to the electric motor 6 can be executed by means of the inverter circuit 42. On the other hand, if the starting switch 38 has been turned to the START position, the vehicle ECU 22 advances the process to Step S5, in which the vehicle ECU 22 again determines based on the result of judgment by the inverter ECU 26 whether or not the control of the power supply to the electric motor 6 can be executed by means of the inverter circuit 42. In this case, the inverter ECU 26 provides the same judgment result as in Step S1, and therefore, the decision of Step S1 may be used in Step S5.

If the vehicle ECU 22 determines in Step S5 that the control of the power supply to the electric motor 6 is not possible to be executed by means of the inverter circuit 42, the vehicle ECU 22 advances the process to Step S6.

In Step S6, the vehicle ECU 22 disengages the clutch 4 to disconnect the output shaft of the engine 2 from the rotary shaft of the electric motor 6, and then operates the starter motor 56 to crank the engine 2. Also, the vehicle ECU 22 instructs the engine ECU 24 to operate the engine 2. On receiving the instruction from the vehicle ECU 22, the engine ECU 24 initiates fuel supply to the engine 2. As a result, the engine 2 is started, whereupon the start control ends.

On the other hand, if the vehicle ECU 22 determines in Step S5 that the control of the power supply to the electric motor 6 can be executed by means of the inverter circuit 42, the vehicle ECU 22 advances the process to Step S7.

In Step S7, the vehicle ECU 22 ascertains that the clutch 4 is engaged and also that the transmission 8 is in the neutral position. Then, the vehicle ECU 22 notifies the inverter ECU 26 of the necessary output torque of the electric motor 6 for starting the engine 2, and also instructs the engine ECU 24 to operate the engine 2.

On receiving the notification from the vehicle ECU 22, the inverter ECU 26 operates the electric motor 6 as a motor and causes the electric motor 6 to output the torque as instructed from the vehicle ECU 22, thereby cranking the engine 2. At this time, the engine ECU 24 starts fuel supply to the engine 2 in response to the instruction from the vehicle ECU 22, and thus the engine 2 is started, whereupon the start control is terminated.

The start control for the engine 2 is executed in this manner. Consequently, when the suppression of the inrush current by the inrush current suppression units 46 is not finished yet, as in the case where the starting switch 38 is turned from the OFF to the ON position and then to the START position immediately thereafter, the engine 2 is started by the starter motor 56 as soon as the starting switch 38 is turned to the START position. It is therefore possible to prevent the driver from mistaking the time delay, which is required until the control of the power supply to the electric motor 6 becomes possible to be executed, for a failure and to improve the driver's operation feeling in starting the engine 2.

When the starting switch 38 is turned to the START position after the control of the power supply to the electric motor 6 becomes possible to be executed, as in the case where the starting switch 38 is turned from the OFF to the ON position and, after a while, turned to the START position, the engine 2 is started by the electric motor 6. In this case, the engine 2 can be started quietly. Also, since it is unnecessary to use the starter motor every time the engine is started, the service life of the starter motor can be prolonged.

Especially, when starting the engine 2, the driver can confirm by the indicator lamp 60 that the control of the power supply to the electric motor 6 can be executed, before turning the starting switch 38 to the START position. Accordingly, when the driver intends to use the electric motor 6 to start the engine 2, he/she has only to turn the starting switch 38 to the START position at suitable timing while watching the indicator lamp 60, thus allowing the driver to select with ease the starting mode he/she desires.

Further, when the main contacts 44 of the connection units 40 are closed to complete the connection between the battery 18 and the inverter circuit 42, the inverter ECU 26 judges that the control of the power supply to the electric motor 6 has become possible to be executed by means of the inverter circuit 42. Thus, in cases where the connection between the battery 18 and the inverter circuit 42 is incomplete, the electric motor 6 is not operated for starting the engine 2. In such cases, the engine 2 is started reliably by the starter motor 56.

Also, when the suppression of the inrush current by the inrush current suppression units 46 is finished, the inverter ECU 26 judges that the control of the power supply to the electric motor 6 has become possible to be executed by means of the inverter circuit 42. It is therefore possible to avoid a situation where the electric motor 6 is operated to start the engine 2 even though the inrush current is being suppressed by the inrush current suppression units 46 and thus adequate power cannot be supplied to the inverter circuit 42 from the battery 18. In such cases, the engine 2 can be started without fail by the starter motor 56.

While the control device for the hybrid electric vehicle according to an embodiment of the present invention has been described, the present invention is not limited to the foregoing embodiment alone.

For example, in the above embodiment, the electric motor 6 is arranged between the clutch 4 and the transmission 8, but the arrangement of the components is not limited to such arrangement. The electric motor 6 may be arranged between the engine 2 and the clutch 4, for example, and the present invention is equally applicable to hybrid electric vehicles with such configuration.

Also, in the above embodiment, a diesel engine is used as the engine 2. The type of engine is, however, not limited to diesel engine and may be gasoline engine.

Further, in the foregoing embodiment, a permanent-magnetic synchronous motor is used as the electric motor 6, but the type of electric motor to be used is also not limited to such an electric motor.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A control device for a hybrid electric vehicle which includes an electric motor and an engine and which is arranged such that a driving force of the electric motor can be transmitted to driving wheels and a rotary shaft of the electric motor can be coupled with an output shaft of the engine, the control device comprising:
a battery which stores electric power to be supplied to the electric motor;
power control means adapted to be supplied with electric power from the battery, for executing a control of power supply to the electric motor;
control judging means for judging whether or not the control of the power supply to the electric motor can be executed by the power control means;
a starter motor provided separately from the electric motor and capable of starting the engine by transmitting driving force generated thereby to the output shaft of the engine;
a starting switch adapted to be switched to one of at least three positions including first, second and third positions; and
start control means for starting power supply from the battery to the power control means when the starting switch is switched from the first position to the second position, wherein,
when the starting switch is switched from the second position to the third position, the start control means causes the power control means to execute the control of the power supply to the electric motor to start the engine by the electric motor if it is judged by the control judging means that the control of the power supply to the electric motor can be executed by the power control means, and, on the other hand, the start control means starts the engine by the starter motor if it is judged by the control judging means that the control of the power supply to the electric motor is not possible to be executed by the power control means.

2. The control device for a hybrid electric vehicle according to claim 1, wherein
the power control means includes an inverter circuit for adjusting electric power supplied from the battery to the electric motor, and connection means for connecting the battery and the inverter circuit;
the start control means causes the connection means to start connection between the battery and the inverter circuit when the starting switch is switched from the first position to the second position; and
when the connection between the battery and the inverter circuit by the connection means is completed, the control judging means judges that the control of the power supply to the electric motor can be executed by the power control means.

3. The control device for a hybrid electric vehicle according to claim 2, wherein
the connection means includes an inrush current suppression circuit arranged for suppressing an inrush current that flows when the battery is connected to the inverter circuit; and
when the suppression of the inrush current by the inrush current suppression circuit is finished, the control judging means judges that the control of the power supply to the electric motor can be executed by the power control means.

4. The control device for a hybrid electric vehicle according to claim 1, further comprising
confirmation means for providing an indication and/or a notification based on a result of judgment by the control judging means as to whether or not the control of the power supply to the electric motor can be executed by the power control means.
